(19) United States
(12) Patent Application Publication
(10) Pub. No.: US 2004/0064580 A1
(43) Pub. Date: Apr. 1, 2004

(54) Thread efficiency for a multi-threaded network processor

(76) Inventors: Lee Booi Lim, Butterworth (MY); Kean Hong Boey, Bukit Mertajam (MY); Kenny Lai Kian Puah, Bukit Mertajam (MY)

Correspondence Address: KENYON & KENYON (SAN JOSE), 333 WEST SAN CARLOS ST., SUITE 600, SAN JOSE, CA, 95110, US

(21) Appl. No.: 10/262,031

(22) Filed: Sep. 30, 2002

(51) Int. Cl. G06F 15/173; G06F 9/00

(52) U.S. Cl. 709/238

(57) ABSTRACT

A system and a method for improving network processing efficiency are disclosed. A route table manager assigns a set of data to be transmitted and the accompanying route to a micro-engine and its program threads based on the current workload distribution. The workload distribution is determined by looking at the number of routes assigned to a program thread. The network processing efficiency is further improved by grouping timer values into subsets when stored in memory. A separate tracker thread tracks the countdown timer for each worker thread, the worker thread performing the actual network processing.

### BACKGROUND INFORMATION

The present invention relates to network processors. More specifically, the present invention relates to improving thread efficiency in network processors.

Network processors are often used to process data on a network line. Among the functions the network processors perform is the transformation of a data set into a network format that allows the data set to be transmitted across a network. A network format usually involves breaking up the data set to be separated into a set of packets. In some formats the packets are of equal size, in other formats the size can be varied. The packets then have header information appended to the beginning of the packets. The header information can include format identification, packet group identification to keep the packet with the other packets created from the data set, packet order to allow reassembly in the proper order, and some form of error notification or correction. The header information can also include the destination of the packet as well as routing information. The network format can be asynchronous transfer mode (ATM; Multiprotocol Over ATM, Version 1.0, July 1998) or a different format.

As a multithreaded processor, a network processor can simultaneously service numerous data sets, each data set having a different destination. Using the packets' destination, the thread uses a route table to look up the route the data set should take in being sent to the destination. The route would include a list of nodes the packet would be sent through when being transmitted to the destination. A thread is assigned to a route on a first come, first serve basis. Various threads can become overloaded when threads are in charge of multiple active routes, or in charge of sizeable data loads.

Occasionally, data sets are so large that a single thread or processor can delay the processing of subsequent threads. To prevent this delay, the thread periodically checks a timer value associated with the data set as the same thread processes the data set. When the processing of the data set has taken more time than allotted by the timer value, as determined using a clock signal, the processing is cut off and the data set is sent as is. If a data packet, or in the case of ATM format the data cell, has not completely used the available payload space, the remaining bits are set to zero and the data packet is sent. However, the routine checking of the timer by the thread can cause a delay in the transmission of a data packet. Further, if the number of virtual circuits is large, many countdown timers may be active at any one time.

### BRIEF DESCRIPTION OF THE DRAWINGS

FIG. 1 provides an illustration of one embodiment of a processor system according to the present invention.

FIG. 2 provides an illustration of one embodiment of route table management mapping to micro-engines according to the present invention.

FIG. 3 describes in a flowchart one embodiment of the processes performed by the processor in allocating a route and data set to a thread according to the present invention.

FIGS. 4a-b provide an illustration of the timer control performed by the processor according to the present invention.

### DETAILED DESCRIPTION

A system and a method for improving network processing efficiency are disclosed. In one possible embodiment, a route table manager assigns a set of data to be transmitted and the accompanying route to a micro-engine and its program threads based on the current workload distribution. The workload distribution may be determined by looking at the number of routes assigned to a program thread. The network processing efficiency may be further improved by grouping timer values into subsets when stored in memory. A separate tracker thread may, when executed, track the countdown timer for each worker thread, the worker thread performing the actual network processing.

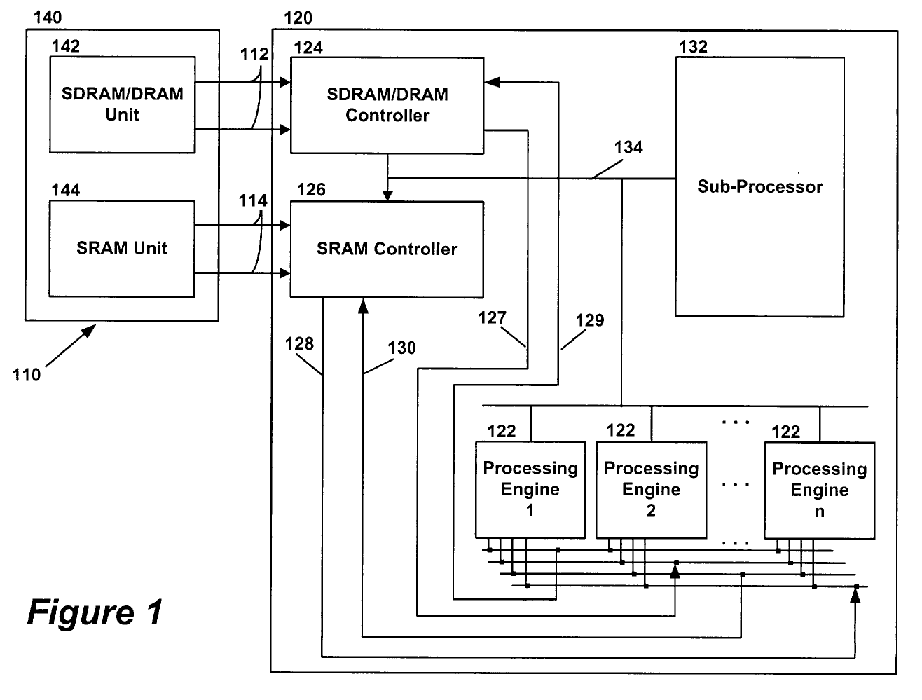

FIG. 1 is a block diagram of a processing system, in accordance with an embodiment of the present invention. In FIG. 1, a computer processor system 110 may include a parallel, hardware-based multithreaded network processor 120 coupled by a pair of memory buses 112, 114 to a memory system or memory resource 140. Memory system 140 may include a synchronous dynamic random access memory (SDRAM) unit 142 and a static random access memory (SRAM) unit 144. The processor system 110 may be especially useful for tasks that can be broken into parallel subtasks or operations. Specifically, hardware-based multithreaded processor 120 may be useful for tasks that require numerous simultaneous procedures rather than numerous sequential procedures. Hardware-based multithreaded processor 120 may have multiple microengines or processing engines 122 each processing multiple hardware-controlled threads that may be simultaneously active and independently worked to achieve a specific task.

Processing engines 122 each may maintain program counters in hardware and states associated with the program counters. Effectively, corresponding sets of threads may be simultaneously active on each processing engine 122.

In FIG. 1, in accordance with an embodiment of the present invention, multiple processing engines 1-n 122, where (for example) n=8, may be implemented with each processing engine 122 having capabilities for processing eight hardware threads. The eight processing engines 122 may operate with shared resources including memory resource 140 and bus interfaces. The hardware-based multithreaded processor 120 may include a SDRAM/dynamic random access memory (DRAM) controller 124 and a SRAM controller 126. SDRAM/DRAM unit 142 and SDRAM/DRAM controller 124 may be used for processing large volumes of data, for example, processing of network payloads from network packets. SRAM unit 144 and SRAM controller 126 may be used in a networking implementation for low latency, fast access tasks, for example, accessing look-up tables, core processor memory, and the like.

In accordance with an embodiment of the present invention, push buses 127, 128 and pull buses 129, 130 may be used to transfer data between processing engines 122 and SDRAM/DRAM unit 142 and SRAM unit 144. In particular, push buses 127, 128 may be unidirectional buses that move the data from memory resource 140 to processing engines 122 whereas pull buses 129, 130 may move data from processing engines 122 to their associated SDRAM/DRAM unit 142 and SRAM unit 144 in memory resource 140.

In accordance with an embodiment of the present invention, eight processing engines 122 may access either SDRAM/DRAM unit 142 or SRAM unit 144 based on characteristics of the data. Thus, low latency, low bandwidth data may be stored in and fetched from SRAM unit 144, whereas higher bandwidth data for which latency is not as important, may be stored in and fetched from SDRAM/DRAM unit 142. Processing engines 122 may execute memory reference instructions to either SDRAM/DRAM controller 124 or SRAM controller 126.

In accordance with an embodiment of the present invention, the hardware-based multithreaded processor 120 also may include a sub-processor 132 for loading microcode control for other resources of the hardware-based multithreaded processor 120. In this example, sub-processor 132 may have an XScale™-based architecture manufactured by Intel Corporation of Santa Clara, Calif. A processor bus 134 may couple sub-processor 132 to SDRAM/DRAM controller 124 and SRAM controller 126.

The sub-processor 132 may perform general purpose computer type functions such as handling protocols, exceptions, and extra support for packet processing where processing engines 122 may pass the packets off for more detailed processing such as in boundary conditions. Sub-processor 132 may execute operating system (OS) code. Through the OS, sub-processor 132 may call functions to operate on processing engines 122. Sub-processor 132 may use any supported OS, such as, a real time OS. In an embodiment of the present invention, sub-processor 132 may be implemented as an XScale™ architecture, using, for example, operating systems such as VXWorks® operating system from Wind River International of Alameda, Calif.; μC/OS operating system, from Micrium, Inc. of Weston, Fla., etc.

Advantages of hardware multithreading may be explained in relation to SRAM or SDRAM/DRAM accesses. As an example, an SRAM access requested by a thread from one of processing engines 122 may cause SRAM controller 126 to initiate an access to SRAM unit 144. SRAM controller 126 may access SRAM memory unit 126, fetch the data from SRAM unit 126, and return data to the requesting processing engine 122.

During a SRAM access, if one of processing engines 122 had only a single thread that could operate, that one processing engine would be dormant until data was returned from the SRAM unit 144.

By employing hardware thread swapping within each of processing engines 122 the hardware thread swapping may enable other threads with unique program counters to execute in that same processing engine. Thus, a second thread may function while the worker may await the read data to return. During execution, the second thread accesses SDRAM/DRAM unit 142. In general, while the second thread may operate on SDRAM/DRAM unit 142, and the first thread may operate on SRAM unit 144, a third thread, may also operate in a third one of processing engines 122. The third thread may be executed for a certain amount of time until it needs to access memory or perform some other long latency operation, such as making an access to a bus interface. Therefore, processor 120 may have simultaneously executing bus, SRAM and SDRAM/DRAM operations that are all being completed or operated upon by one of processing engines 122 and have one more thread available to be processed.

The hardware thread swapping may also synchronize completion of tasks. For example, if two threads hit a shared memory resource, for example, SRAM memory unit 144, each one of the separate functional units, for example, SRAM controller 126 and SDRAM/DRAM controller 124, may report back a flag signaling completion of an operation upon completion of a requested task from one of the processing engine thread. Once the processing engine executing the requesting thread receives the flag, the processing engine may determine which thread to turn on.

In an embodiment of the present invention, the hardware-based multithreaded processor 120 may be used as a network processor. As a network processor, hardware-based multithreaded processor 120 may interface to network devices such as a Media Access Control (MAC) device, for example, a 10/100BaseT Octal MAC device or a Gigabit Ethernet device (not shown). In general, as a network processor, hardware-based multithreaded processor 120 may interface to any type of communication device or interface that receives or sends a large amount of data. Similarly, computer processor system 110 may function in a networking application to receive network packets and process those packets in a parallel manner.

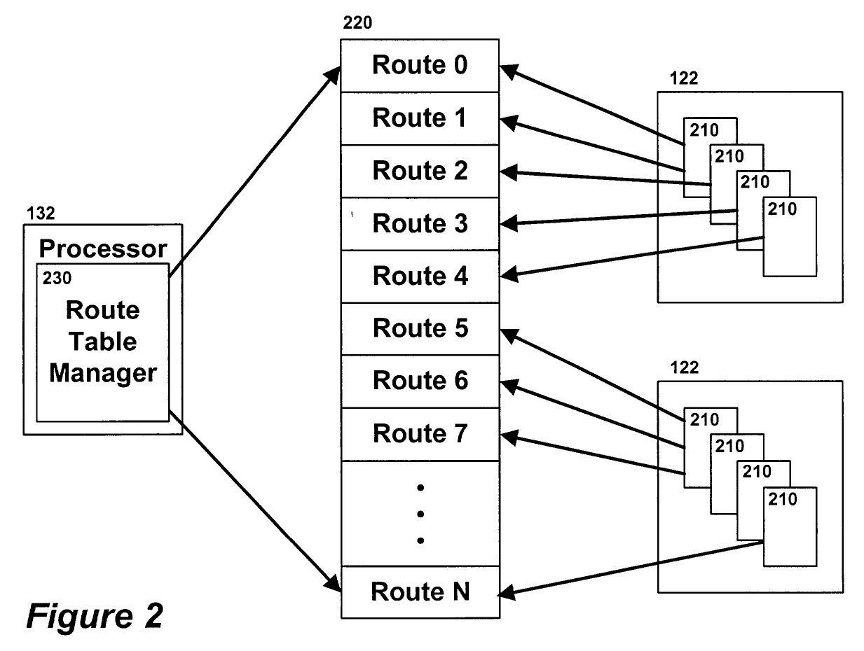

One possible embodiment of route table mapping to micro-engines is illustrated in FIG. 2. Each micro-engine 122 may run a number of program threads 210. These threads 210 perform a variety of tasks. Among the tasks performed by these threads 210 are processing the data, converting the data into a format suitable for transmission, and managing the transmission of the data to a specified destination. A route for each available destination may be contained in a route table 220. The route table 220 may be stored in the random access memory (RAM), either in the static RAM (SRAM) 144 or the synchronous dynamic RAM (SDRAM) 142. As each thread 210 processes a set of data to be sent to a specific destination, a route table manager 230 assigns the thread 210 a route from the route table 220 based on the destination. A sub-processor 132 may act as a route table manager 230. A thread may be assigned multiple routes.

In one possible embodiment, the connection setup is bi-directional, so that data may be sent along that route and received along that route. A route link control (RLC) identifier may be mapped to a route, with the route table manager dividing the pool of RLC identifiers into groups. The route table manager may assign a group of RLC identifiers and the mapped routes to a specific thread. The connection setups with similar routes may be allocated into the same grouping of RLC identifiers to enable the thread to handle the same type of traffic. Similar routes may have nodes in common. Every time the route table manager receives a connection setup request, an RLC identifier may be provided by an RLC identifier free list. The number of routes per thread may be incremented by one, allowing the route table manager to track the total number of routes being allocated in each group.

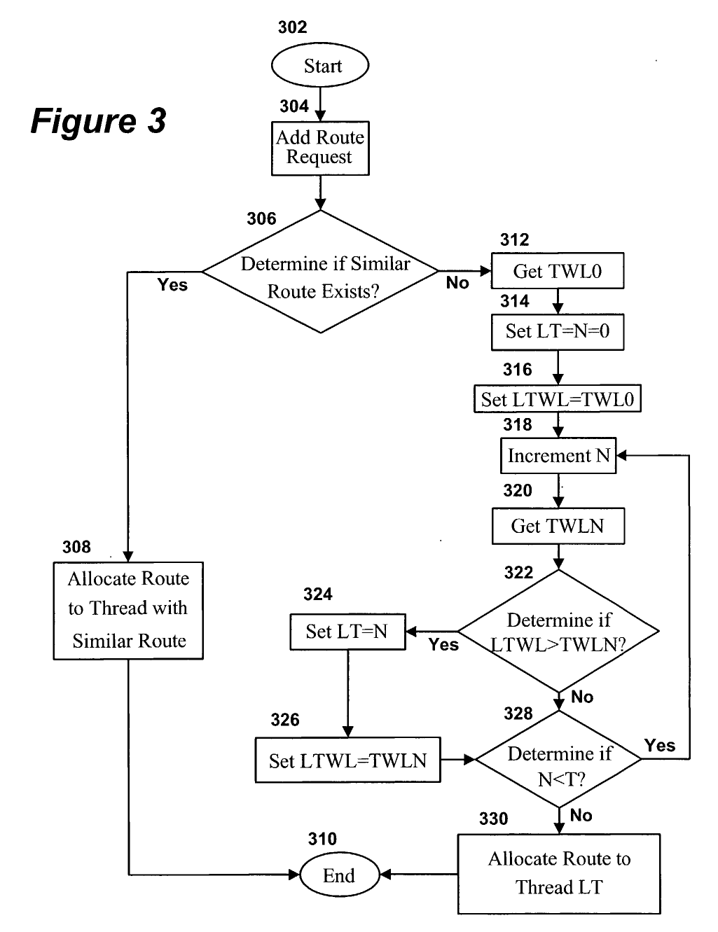

FIG. 3 illustrates in one possible embodiment a process for assigning a route to a thread. The process starts (Block 302) when a route is requested to be added through execution of a thread (Block 304). The route table manager 230 checks to see if a similar route exists (Block 306). If a similar route exists (Block 306), the route is allocated to a thread with a similar route (Block 308) and the process is finished (Block 310). If no similar route exists (Block 308), the workload of the first thread or processor is requested (Block 312). A pointer indicating the thread with the least workload (LT) and a counter (N) is set to zero (Block 314). The level of the thread with the least workload (LTWL) is set to the workload of the first thread (Block 316). The counter is incremented (Block 318) and the next thread workload (TWLN) is retrieved (Block 320). If the thread workload level is less than the least thread workload level (Block 322), the pointer is set to the new thread (Block 324) and the least thread workload level is set equal to the current thread workload level (Block 326). The route table manager then checks if all the threads (T) have been checked (Block 328). If the thread workload level is not less than the least thread workload level (Block 322), the route table manager checks if all the threads have been checked (Block 328). If some of the threads have not been checked (328), the counter is incremented (Block 318) and the comparisons are repeated. If all of the threads have been checked (Block 328), the route table manager allocates the route to the thread indicated by the thread pointer LT (Block 330), and the process is finished (Block 310).

In one possible embodiment, the efficiency of the thread management is further improved by minimizing memory accesses and processing latency in respect to accessing countdown timers values. The timers may be stored in a packed format with a subset of timer values stored in a single memory location, minimizing access to memory by reading multiple timer values when a single location is read. The subset may include up to four timers in this embodiment. One instruction may read multiple locations, allowing an even greater number of timer values to be read.

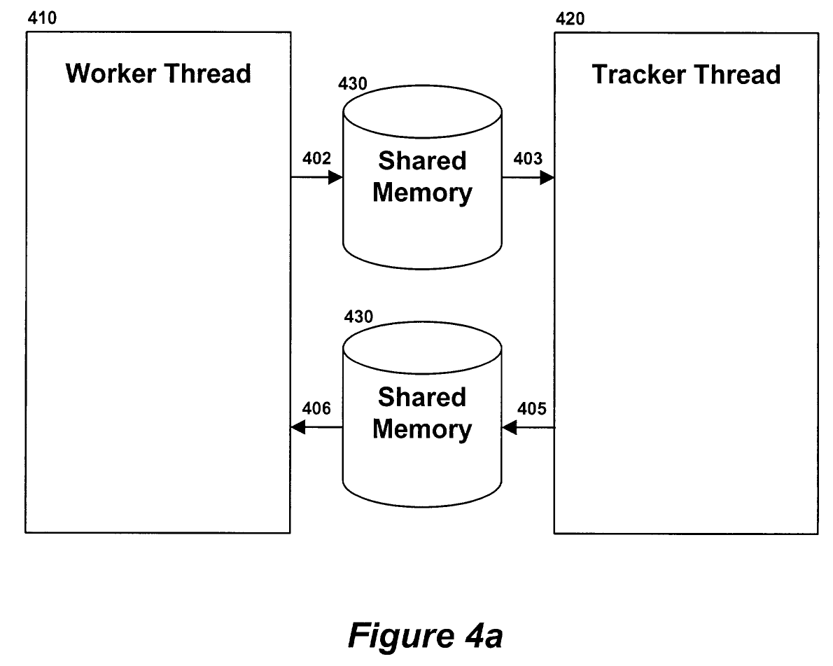

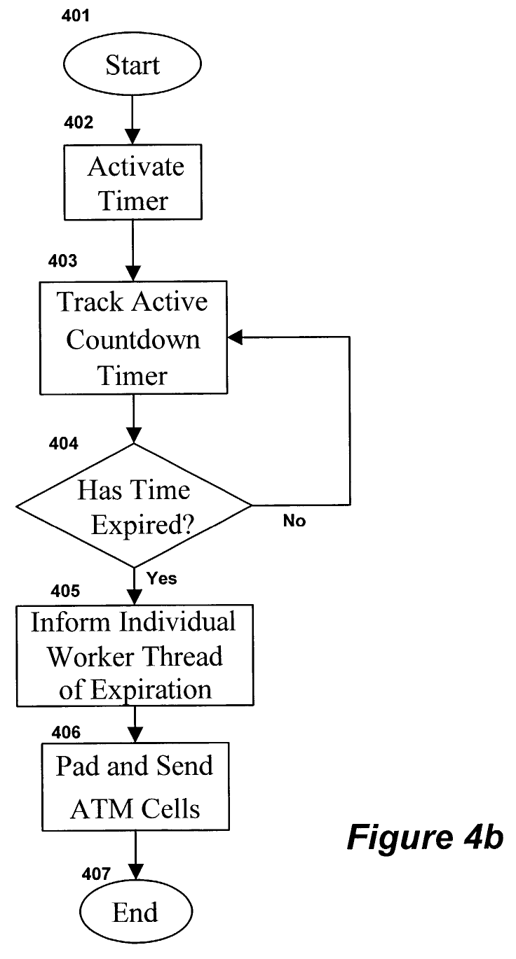

In one possible embodiment, each micro-engine has a tracker thread in addition to a worker thread, the sole responsibility of the tracker thread being to track the countdown timer while the worker thread performs the network processing. One tracker thread may service every worker thread in the micro-engine. FIG. 4a illustrates in a block diagram one possible embodiment of the interaction of the worker thread 410 and the decoupled tracker thread 420 through the shared memory 430. FIG. 4b shows a timer checking process for the embodiment shown in FIG. 4a. For example, the worker thread 410 starts (Block 401) by activating the countdown timer (Block 402). The tracker thread 420 begins tracking the active countdown timer (Block 403). If time has not expired (Block 404), the tracker thread 420 continues to track the countdown timer (Block 403). If time has expired (Block 404), the tracker thread informs the individual worker thread of the expiration signaled by the active countdown timer (Block 405). If a timeout has occurred, the worker thread 410 pads and sends the data packet (Block 406), ending the process (Block 407). Thus, the processing of the worker thread may be more efficient since accesses to the active countdown timer are not necessary during this processing.

Although several embodiments are specifically illustrated and described herein, it will be appreciated that modifications and variations of the present invention are covered by the above teachings and within the purview of the appended claims without departing from the spirit and intended scope of the invention.

What is claimed is:

1. A system, comprising:
a random access memory to store a route table;
a micro-engine to execute a set of threads, wherein at least one of the set of threads is a worker thread that controls transmissions over a variable quantity of routes in the route table; and
a sub-processor to assign the at least one worker thread to transmit a set of data over one or more routes in the route table, wherein the sub-processor assigns the at least one worker thread based on a determination of a workload of the worker thread.

2. The system of claim 1, wherein the determination of the workload of the worker thread includes counting the quantity of routes controlled by the worker thread.

3. The system of claim 1, wherein the sub-processor selects the worker thread based in further part on a size of the set of data to be sent.

4. The system of claim 1, wherein the sub-processor selects the worker thread based in further part on a similar route being present among the quantity of routes.

5. The system of claim 1, further comprising a storage memory to store a set of timer values, with a timer value for each active route in the route table.

6. The system of claim 5, wherein the timer values are compressed for storage.

7. The system of claim 5, wherein, for a subset of the set of timer values, the timer values are stored at the same memory location.

8. The system of claim 1, wherein the micro-engine operates a tracker thread to track a set of timer values, the tracker thread decoupled from the worker thread.

9. A method, comprising:
storing a route table;
operating a worker thread of a set of threads to control transmissions over a variable quantity of routes in the route table;
selecting the worker thread based in part on a determination of a workload of the worker thread; and
assigning the worker thread of the set of threads to transmit a set of data over a route of the route table.

10. The method of claim 9, wherein the determination of the workload of the worker thread includes counting the quantity of routes controlled by the worker thread.

11. The method of claim 9, wherein the determination of the workload of the worker thread includes determining a size of a total amount of data being transmitted over all the routes controlled by the worker thread.

12. The method of claim 9, further including selecting the worker thread based in further part on a similar route being present among the quantity of routes.

13. The method of claim 9, further including storing a set of timer values, with a timer value for each active route in the route table.

14. The method of claim 13, further including compressing the timer values for storage.

15. The method of claim 13, further including, for a subset of the set of timer values, storing the timer values at the same memory location.

16. The method of claim 9, operating a tracker thread to track a set of timer values, the tracker thread decoupled from the worker thread.

17. A set of instructions residing in a storage medium, said set of instructions capable of being executed by a processor to implement a method for processing data, the method comprising:
storing a route table;
operating a worker thread of a set of threads to control transmissions over a variable quantity of routes in the route table;
selecting the worker thread based in part on a workload for the worker thread; and
assigning the worker thread of the set of threads to transmit a set of data over a route of the route table.

18. The set of instructions of claim 17, wherein the determination of the workload of the worker thread includes counting the quantity of routes controlled by the worker thread.

19. The set of instructions of claim 17, further including selecting the worker thread based in further part on a size of the set of data to be sent.

20. The set of instructions of claim 17, further including selecting the worker thread based in further part on a similar route being present among the quantity of routes.

21. The set of instructions of claim 17, further including storing a set of timer values, with a timer value for each active route in the route table.

22. The set of instructions of claim 21, further including compressing the timer values for storage.

23. The set of instructions of claim 21, further including, for a subset of the set of timer values, storing the timer values at the same memory location.

24. The set of instructions of claim 17, operating a tracker thread to track a set of timer values, the tracker thread decoupled from the worker thread.

25. A system, comprising:
a random access memory to store a route table;
a storage memory to store a set of timer values, with a timer value for each active route in the route table; and
a micro-engine to operate a set of threads, wherein the set of threads includes a worker thread to control transmissions over a variable quantity of routes in the route table and a tracker thread decoupled from the worker thread to track the set of timer values.

26. The system of claim 25, wherein the timer values are compressed for storage.

27. The system of claim 25, wherein, for a subset of the set of timer values, the timer values are stored at the same memory location.

28. The system of claim 25, wherein one tracker thread services multiple worker threads.

29. A method, comprising:
storing a route table;
storing a set of timer values, with a timer value for each active route in the route table;
operating a worker thread to control transmissions over a variable quantity of routes in the route table; and
operating a tracker thread decoupled from the worker thread to track the set of timer values.

30. The method of claim 29, further including compressing the timer values for storage.

31. The method of claim 29, further including, for a subset of the set of timer values, storing the timer values at the same memory location.

32. The method of claim 29, further including servicing multiple worker threads with one tracker thread.

33. A set of instructions residing in a storage medium, said set of instructions capable of being executed by a processor to implement a method for processing data, the method comprising:
storing a route table;
storing a set of timer values, with a timer value for each active route in the route table;
operating a worker thread to control transmissions over a variable quantity of routes in the route table; and
operating a tracker thread decoupled from the worker thread to track the set of timer values.

34. The set of instructions of claim 33, further including compressing the timer values for storage.

35. The set of instructions of claim 33, further including, for a subset of the set of timer values, storing the timer values at the same memory location.

36. The set of instructions of claim 33, further including servicing multiple worker threads with one tracker thread.
